(19) United States
(12) Patent Application Publication
(10) Pub. No.: US 2019/0347905 A1
(43) Pub. Date: Nov. 14, 2019

(54) INTERACTIVE ELECTRONIC GAME MACHINE FOR MATRIX-BASED GAME RESPONSIVE TO A CONTINUOUS MOVEMENT INPUT

(71) Applicant: Aristocrat Technologies Australia Pty Limited, North Ryde (AU)

(72) Inventor: Brian Pate, Concord, CA (US)

(21) Appl. No.: 15/979,034

(22) Filed: May 14, 2018

(51) Int. Cl. G07F 17/32; A63F 1/00; G06Q 50/34

(52) U.S. Cl. CPC G07F 17/3293; G07F 17/3209; A63F 1/00; A63F 2001/008; A63F 2001/005; A63F 2250/142; G06Q 50/34

(57) ABSTRACT

Disclosed is an interactive electronic game machine configured to receive and interpret a continuous movement input from a user for a matrix-based game. In particular, an interactive electronic poker game employs a game controller configured to receive an input from a player corresponding to a continuous movement. The continuous movement corresponds to a path where two or more symbols that represent playing cards along the path are selected to form a winning poker hand. In examples, the symbols are arranged in a matrix, such that a player makes a poker hand by swiping, or tracing a path, across connected symbols within the matrix to group symbols together that form a winning hand.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player (RTP=return to player) over the course of many plays or instances of the game. The RTP and randomness of the RNG are critical to ensuring the fairness of the games and are therefore highly regulated. Upon initiation of play, the RNG randomly determines a game outcome and symbols are then selected which correspond to that outcome. Notably, some games may include an element of skill on the part of the player and are therefore not entirely random.

### SUMMARY

An interactive electronic game machine configured to receive and interpret a continuous movement input from a user for matrix-based game is disclosed. In particular, an interactive electronic poker game employs a game controller configured to receive an input from a player corresponding to a continuous movement. The continuous movement corresponds to a path where two or more symbols that represent playing cards along the path are selected to form a winning poker hand. In examples, the symbols are arranged in a matrix, such that a player makes a poker hand by swiping, or tracing a path, across connected symbols within the matrix to group symbols together that form a winning hand.

In some examples, after each grouping or selection, the symbols are evaluated to determine a game outcome. A player earns points based on the outcome, with higher points being assigned to more valuable poker hands. In some examples, card symbols collapse after game evaluation and are replaced by new symbols, opening up new play options and strategies.

As described more fully with respect to the several figures, the interactive EGM of the present disclosure provides a non-conventional arrangement for an EGM, in particular an electronic poker game. Conventional electronic poker is presented to a player as a single hand of five cards, much as a physical hand would be. The player would tap an electronic playing card to reveal its value, tap an electronic deck to acquire additional cards, and/or tap a complete/wager icon to complete and submit a hand. Building a hand required multiple interactions between the player and the EGM, requiring the EGM to constantly update displayed poker hands while the player builds a poker hand, as the player waits for a response to each input for a response, delaying gameplay.

The described interactive EGM is configured to present a plurality of symbols representing poker playing cards within a matrix. The disclosed matrix based interactive electronic poker game can provide a plurality of poker hands to the player in a single instance, and is configured to receive a continuous movement input from the player to select the symbols for a desired poker hand. Thus, a continuous movement across the matrix allows the user to select up to five cards to build a poker hand. The means by which the user interacts with the game (e.g., a continuous movement across a touchscreen displaying the matrix) results in fewer instances of player input to achieve a poker hand (and/or multiple poker hands), providing a more efficient, more responsive, and more accurate interactive experience, while employing fewer computing resources than would be required on general purpose machinery to effect an interactive electronic game.

### BRIEF DESCRIPTION OF THE DRAWINGS

FIG. 1 is an exemplary diagram showing several EGMs networked with various gaming related servers.

FIG. 2 is a block diagram showing various functional elements of an exemplary EGM.

FIG. 3A illustrates an exemplary game matrix for interactive play of an electronic poker game.

FIG. 3B illustrates the exemplary game matrix of FIG. 3A following a first game outcome.

FIGS. 4A and 4B illustrate alternative exemplary game matrices for interactive play of an electronic poker game.

FIG. 5 illustrates a flow chart for playing an interactive electronic poker game.

### DETAILED DESCRIPTION

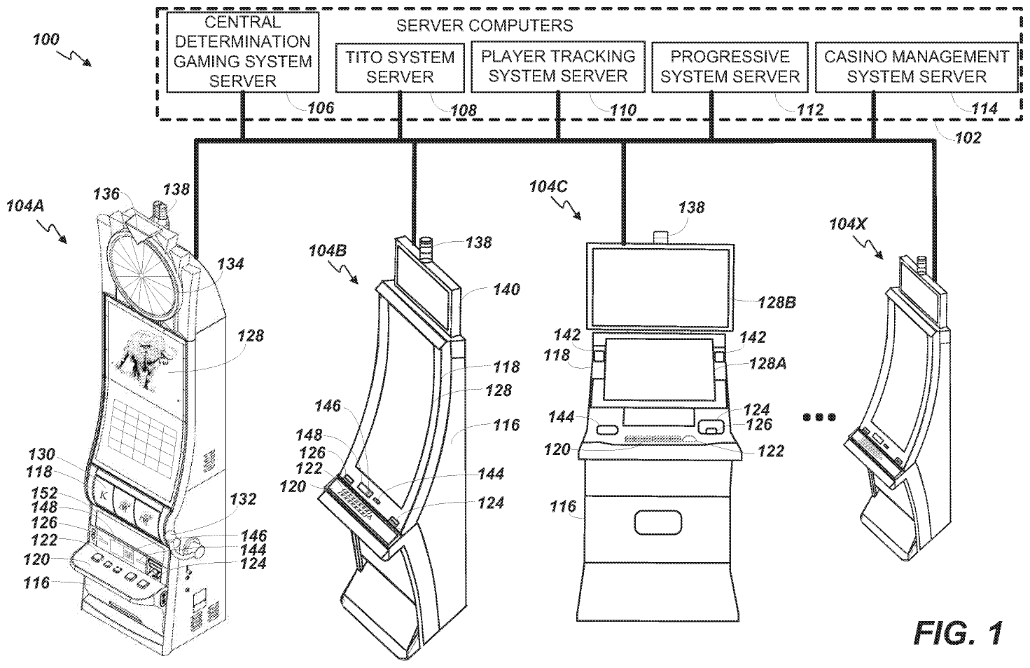

FIG. 1 illustrates several different models of EGMs, which may be networked to various gaming related servers. The present invention can be configured to work as a system 100 in a gaming environment including one or more server computers 102 (e.g., slot servers of a casino) that are in communication, via a communications network, with one or more gaming devices 104A-104X (EGMs, slots, video poker, bingo machines, etc.). The gaming devices 104A-104X may alternatively be portable and/or remote gaming devices such as, but not limited to, a smart phone, a tablet, a laptop, or a game console.

Communication between the gaming devices 104A-104X and the server computers 102, and among the gaming devices 104A-104X, may be direct or indirect, such as over the Internet through a website maintained by a computer on a remote server or over an online data network including commercial online service providers, Internet service providers, private networks, and the like. In other embodiments, the gaming devices 104A-104X may communicate with one another and/or the server computers 102 over RF, cable TV, satellite links and the like.

In some embodiments, server computers 102 may not be necessary and/or preferred. For example, the present invention may, in one or more embodiments, be practiced on a stand-alone gaming device such as gaming device 104A, gaming device 104B or any of the other gaming devices 1040-104X. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction, which may be aligned in rows or banks of similar devices for placement and operation on a casino floor. The gaming device 104A often includes a main door 116, which provides access to the interior of the cabinet. Gaming device 104A typically includes a button area or button deck 120 accessible by a player that is configured with input switches or buttons 122, an access channel for a bill validator 124, and/or an access channel for a ticket printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118, which may be used to determine an outcome to the game.

In many configurations, the gaming machine 104A may have a main display 128 (e.g., video display monitor) mounted to, or above, the gaming display area 118. The main display 128 can be a high-resolution LCD, plasma, LED, or OLED panel, which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are well known in the art and are used to generate and track unique bar-codes or other indicators printed on tickets to allow players to avoid the use of bills and coins by loading credits using a ticket reader and cashing out credits using a ticket-out printer 126 on the gaming device 104A.

In some embodiments, a player tracking card reader 144, a transceiver for wireless communication with a player's smartphone, a keypad 146, and/or an illuminated display 148 for reading, receiving, entering, and/or displaying player tracking information is provided in EGM 104A. In such embodiments, a game controller within the gaming device 104A can communicate with the player tracking server system 110 to send and receive player tracking information. In some examples, the player tracking card reader 144 is further configured to accept a wager and/or credits for gameplay.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152, which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

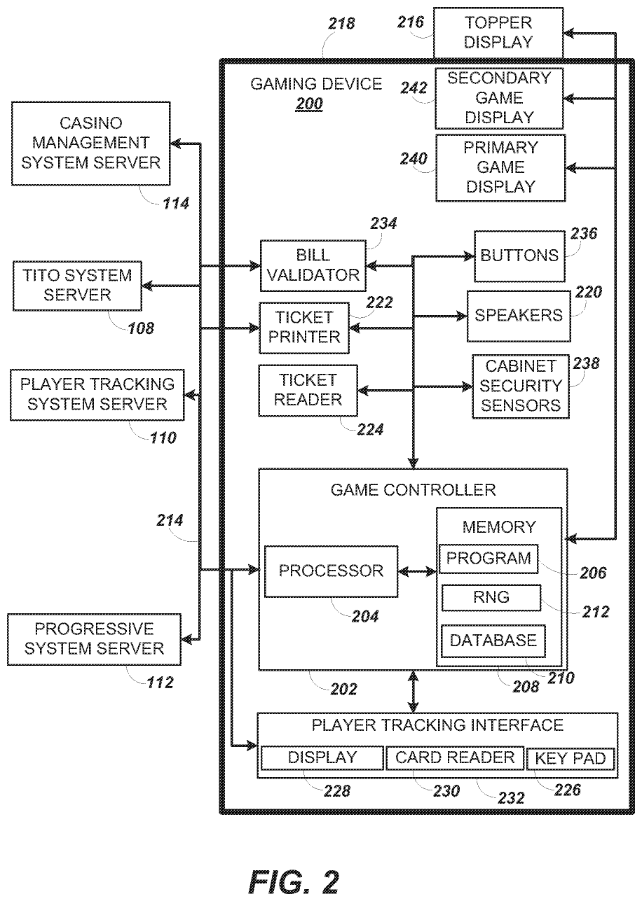

Many or all the above described components can be controlled by circuitry (e.g., a gaming controller) housed inside the main cabinet 116 of the gaming device 104A, the details of which are shown in FIG. 2.

Note that not all gaming devices suitable for implementing embodiments of the present invention necessarily include top wheels, top boxes, information panels, cashless ticket systems, and/or player tracking systems. Further, some suitable gaming devices have only a single game display that includes only a mechanical set of reels and/or a video display, while others are designed for bar counters or table tops and have displays that face upwards.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door 118, which opens to provide access to the interior of the gaming device 104B. The main or service door 118 is typically used by service personnel to refill the ticket-out printer 126 and collect bills and tickets inserted into the bill validator 124. The door 118 may also be accessed to reset the machine, verify and/or upgrade the software, and for general maintenance operations.

Another example gaming device 1040 shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. The games available for play on the gaming device 200 are controlled by a game controller 202 that includes one or more processors 204 and a game that may be stored as game software or a program 206 in a memory 208 coupled to the processor 204. The memory 208 may include one or more mass storage devices or media that are housed within gaming device 200. Within the mass storage devices and/or memory 208, one or more databases 210 may be provided for use by the program 206. A random number generator (RNG) 212 that can be implemented in hardware and/or software is typically used to generate random numbers that are used in the operation of game play to ensure that game play outcomes are random and meet regulations for a game of chance.

Alternatively, a game instance (i.e. a play or round of the game) may be generated on a remote gaming device such as a central determination gaming system server 106 (not shown in FIG. 2 but see FIG. 1). The game instance is communicated to gaming device 200 via the network 214 and then displayed on gaming device 200. Gaming device 200 may execute game software, such as but not limited to video streaming software that allows the game to be displayed on gaming device 200. When a game is stored on gaming device 200, it may be loaded from a memory 208 (e.g., from a read only memory (ROM)) or from the central determination gaming system server 106 to memory 208. The memory 208 may include RAM, ROM or another form of storage media that stores instructions for execution by the processor 204.

The gaming device 200 may include a topper display 216 or another form of a top box (e.g., a topper wheel, a topper screen, etc.) which sits above main cabinet 218. The gaming cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. Ticket printer 222 may be used to print tickets for a TITO system server 108. The gaming device 200 may further include a bill validator 234, buttons 236 for player input, cabinet security sensors 238 to detect unauthorized opening of the cabinet 218, a primary game display 240, and a secondary game display 242, each coupled to and operable under the control of game controller 202.

Gaming device 200 may be connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Gaming devices, such as gaming devices 104A-104X, 200, are highly regulated to ensure fairness and, in many cases, gaming devices 104A-104X, 200 are operable to award monetary awards (e.g., typically dispensed in the form of a redeemable voucher). Therefore, to satisfy security and regulatory requirements in a gaming environment, hardware and software architectures are implemented in gaming devices 104A-104X, 200 that differ significantly from those of general-purpose computers. Adapting general purpose computers to function as gaming devices 200 is not simple or straightforward because of: 1) the regulatory requirements for gaming devices 200, 2) the harsh environment in which gaming devices 200 operate, 3) security requirements, 4) fault tolerance requirements, and 5) the requirement for additional special purpose componentry enabling functionality of an EGM. These differences require substantial engineering effort with respect to game design implementation, hardware components and software.

When a player wishes to play the gaming device 200, he/she can insert cash or a ticket voucher through a coin acceptor (not shown) or bill validator 234 to establish a credit balance on the gaming machine. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views the game outcome on the game displays 240, 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

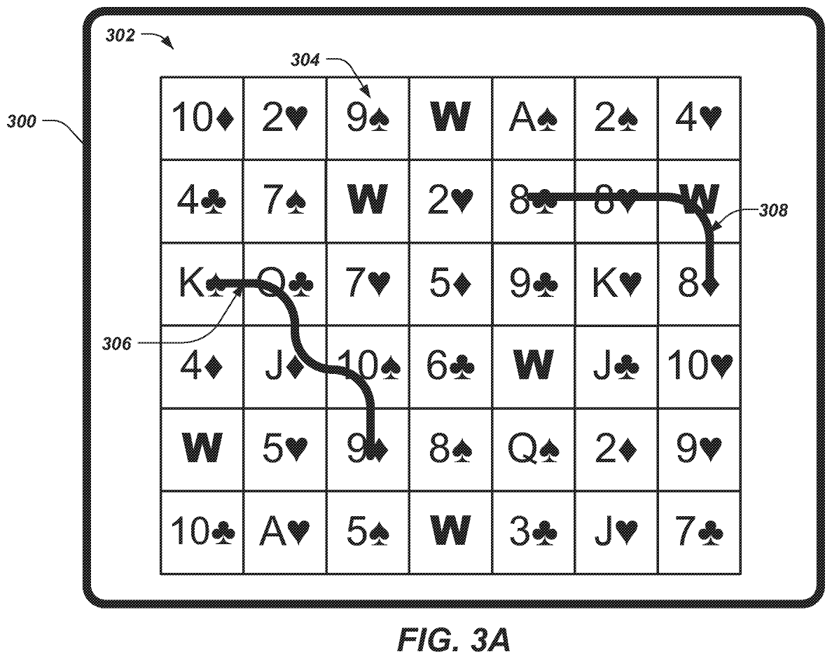

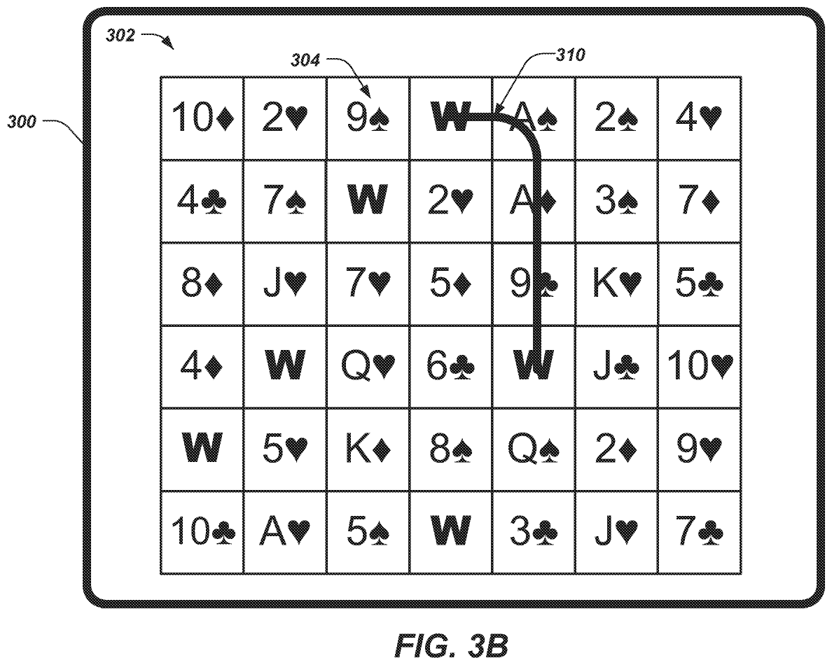

Systems and methods of playing an interactive electronic poker game are disclosed. In particular, a gaming device, such as gaming devices 104A-104X, includes a game controller, such as game controller 202, configured to receive an input from a player representing a path, where two or more symbols that represent a playing card along the path are selected to form a winning poker hand. In examples, symbols 304 are arranged in a matrix 302 adjacent one another, such that a player makes a poker hand by swiping, or tracing a path, across a touchscreen display 300 by using an input device (not shown) to connect symbols 304 within the matrix 302 to group symbols together that form a winning hand, as shown in FIG. 3A. Although illustrated as a 7×6 matrix of symbol locations (i.e. providing 42 cards), a larger or smaller number of symbol locations can be implemented while maintaining the scope and spirit of the present disclosure.

For instance, the gaming device can be configured such that a player selects a first symbol with a first input, selects each subsequent symbol by a second input defined by continuous movement across one or more additional symbols within the matrix 302, and completes the selection by a third input.

The first input can be contacting a touch screen that displays the matrix 302 with an input device, such as with a stylus, a finger, etc. The touch screen can be provided on one or more displays associated with the gaming device(s), such as main display 128A and/or game displays 240, 242. The input device remains in contact with the screen 300 during the continuous movement, which defines a path (e.g., paths 306, 308) over the symbols 304, including at least a first and a second symbol. The third input can be breaking contact between the input device and the touch screen 300, thereby completing the player's selection. In an alternative to breaking contact, selection can be completed by expiration of a timer, lingering on a final selected symbol, another contact with the touchscreen, or other input. In some examples, the input is provided through a mouse, a keyboard, or via a non-contact method, such as tracking a gesture or eye movement from a player, to name but a few.

A variety of inputs and input devices are considered for player interaction with the game device. In some examples, the game is configured for use with a finger, stylus, or other input device, which provides for rapid gameplay through the symbol swiping/matching methods.

The game controller is configured to detect an input gesture from the player via the input device. The gaming machine can include one or more of a smartphone, a tablet computer, a stand-alone wagering system, for example. The touch screen 300 can be utilized to capture user inputs indicative of gestures from the player. For example, a player can swipe across the touch screen 300 to provide inputs indicative of a direction and/or speed of the path. For instance, detecting a finger swipe gesture on the touch-sensitive surface includes detecting a contact event (e.g., touching the input device to the screen) followed by detecting movement along the screen (e.g., while continuing contact with the touch sensitive surface), such as along a path designed to select one or more symbols. In some examples, the touchscreen 300 may determine the user input corresponds to a finger being swiped through one or more symbols.

Thus, the user input can define a traced path (306, 308) through one or more interactive symbols 304. To complete the selection (e.g., the poker hand), the movement is followed by detecting a break in contact with the touchscreen (e.g., lifting the input device). This break in contact signals the completion of the player's selection of symbols. In some examples, the path is a single line. However, the path can be a circle that encloses a number of symbols to make a hand, or other selection process.

As described herein, the path may be used to identify the selected symbols for evaluation. Input gestures on the touchscreen surface (or other touch sensitive input device) can be evaluated for a variety of different characteristics, such as direction of the input device, timing associated with the input (e.g., amount of contact time, rate of movement across the display), and/or intensities of detected contacts (e.g., amount of force). For example, lingering over a symbol or pressing down above a predetermined threshold amount of force can initiate a specific response from the game. For example, a bonus play or increased wager may allow the player to modify the matrix layout. A particular card may become optional, such that it can be replaced by a wild card, or a swap may be allowed between symbols. To implement such a change, one or more input techniques can be recognized by the game controller to allow the player to modify the type or arrangement of symbols within the matrix.

During evaluation of the selected symbols, several groupings of symbols will correspond to a winning hand. In the example of a poker based interactive game, winning hands are based on the relative ranking of poker hands based on a standard deck of 52 cards. Each of the 52 cards in a standard pack of playing cards can be ranked. For example, an ace is the highest value card, followed by king, queen, jack, 10, 9, 8, 7, 6, 5, 4, 3, and 2. There are typically four suits (e.g., heart, diamond, clubs, and spades in an English deck). However, the suits are used for identification purposes and hold no relative rank.

During a traditional game, a poker hand includes five cards. Two or more cards arranged in one of several combinations defines a winning hand. The winning hands, from highest (and most challenging to achieve) to lowest, are a Royal Flush, a Straight Flush, Four of a kind, a Full House, a Flush, a Straight, Three of a Kind, Two Pairs, and a Pair. A higher winning hand in a higher category holds a greater value to the player.

As an example, a Royal Flush is the highest poker hand, which includes an ace, a king, a queen, a jack and a ten. The cards must come from the same suit to be considered a Royal Flush.

A Straight Flush includes five cards from the same suit in order. As multiple straight flushes are possible, the combination of cards with a card of a greater value will garner a greater payout. In evaluating a Straight Flush, an ace can be counted as a low card; however, the ace will take on a low value.

Following a Straight Flush is Four cards of the same kind or rank (e.g., four jacks). Between two winning hands each with fours of a kind, the hand with the higher set of four cards will garner a greater relative payout.

A Full House consists of three cards of one kind or rank, and another two cards of another rank (e.g., three sevens and two tens). Between full houses, the rank of the three cards determines which receives a higher relative payout.

A Flush is five cards of a single suit (e.g., all five cards are hearts). When comparing winning flushes, the highest card receives the higher relative payout.

A Straight is five cards of mixed suits ordered in sequence (e.g., queen through eight of two or more suits). When comparing two winning hands, the one with the higher-ranking top card garners the higher relative payout.

Three of a Kind is three cards of the same rank. When comparing winning hands, threes of a kind the hand in which the three equal cards are of a higher rank will receive a higher relative payout.

Two Pairs is when two sets of pairs, each of equal rank, are together. In a winning hand with two different pairs, the hand with a higher-ranking pair will receive a higher relative payout.

A single Pair is a winning hand with two cards of equal rank. A winning hand with the highest rank cards will receive a higher relative payout (e.g., an ace-ace pair has a greater payout than an eight-eight pair).

In accordance with the wagering game machine described herein, the winning hand combinations can be stored in a media storage device, such as memory 208 of FIG. 2. In some examples, the interactive game may have an online component as well as a stand-alone gaming machine housed in a casino. In this example, the highest winning hand combinations, and/or the bonus features that offer the greatest payout, may be restricted to players within the casino.

As shown, the player can select symbols corresponding to the various winning hands, followed by a game evaluation. In the example of FIG. 3A, a first path 306 crosses through five symbols. In the matrix 302 arrangement shown in FIG. 3A, each symbol along the path 306 shares a border with the next symbol. Thus, each symbol along path 306 is selected for evaluation, resulting in the following winning hand (i.e. a straight): K of spades, Queen of clubs, Jack of diamonds, 10 of spades, and 9 of hearts.

In some examples, a number of winning hands can be offered in a single instance of the matrix. A second path 308 can be traced by the player, adding to the player's reward. As shown, path 308 is traced over three eights of different suit and a single wild symbol. Thus, the winning hand is four of a kind. In the example of FIG. 3A, the player has selected two winning hands, and the payout will reflect these selections. In examples, a payout mechanism (e.g., ticket-out printer 126, either integrated with the gaming device and/or linked via network 214) is in communication with the game controller and configured to cause a payout associated with the game outcome, the level of which is based on the value of the winning hand.

In some examples, after each grouping or selection, the symbols are evaluated to determine a game outcome. A player earns points based on the outcome, with higher points being assigned to more valuable poker hands. In some examples, card symbols “collapse” after game evaluation and are replaced by new symbols, opening up new play options and strategies, as shown in FIG. 3B.

In an example, symbols that have been swiped and selected can collapse and be replaced by new symbols, creating new opportunities for different poker hands. The newly provided symbols can be generated by a predetermined set of instructions or algorithms, or can be selected via the RNG 212, for example. This cycle of selection and replacement of symbols can occur immediately following determination of a winning hand, and/or could result from the expiration of a timer. In the example of FIG. 3B, the symbols that corresponded to the winning hands identified by paths 306, 308 in FIG. 3A were removed, or collapsed, and were replaced by new symbols. As shown, path 310 traces over five symbols, including two aces, a nine and two wild symbols. The resulting hand is a flush, with three of a kind aces, and a pair of nines.

In some game embodiments, the player can be challenged to locate and select a particular hand that may be found within the presented matrix. Locating the desired winning hand may open up additional features, such as increase the player's payout.

Additionally or alternatively, a timer can be employed, such that the player has a limited time period to identify all available winning hands. Such a feature can also be employed with collapsing symbols, such that during the duration of time new opportunities are presented for winning hands as the matrix evolves. The player can receive a bonus (e.g., additional time, increased payout, etc.) if one or more predetermined winning hands are selected (e.g., the highest winning hand in the matrix, all available winning hands, a winning hand comprising no wild symbols, etc.).

In some examples, an interactive poker game can be played in conjunction with a reel type game, such as on gaming device 104A. For instance, the reel game can employ a poker-themed motif shown on reels 130, where the reels stop to display a variety of poker symbols within a matrix formed by the reel positions. In this manner, a player can employ the selection techniques described herein to increase a payout by identifying one or more winning poker hands on the matrix.

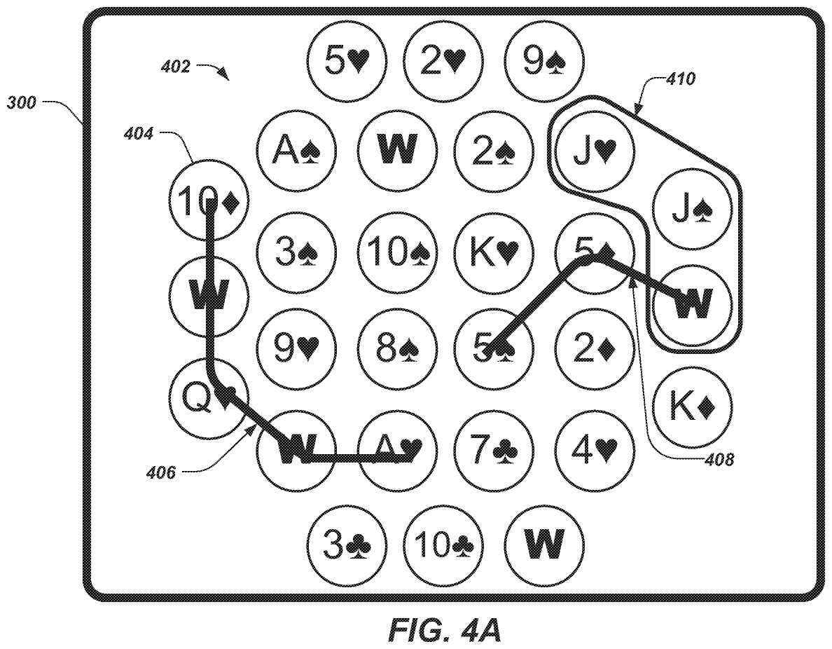

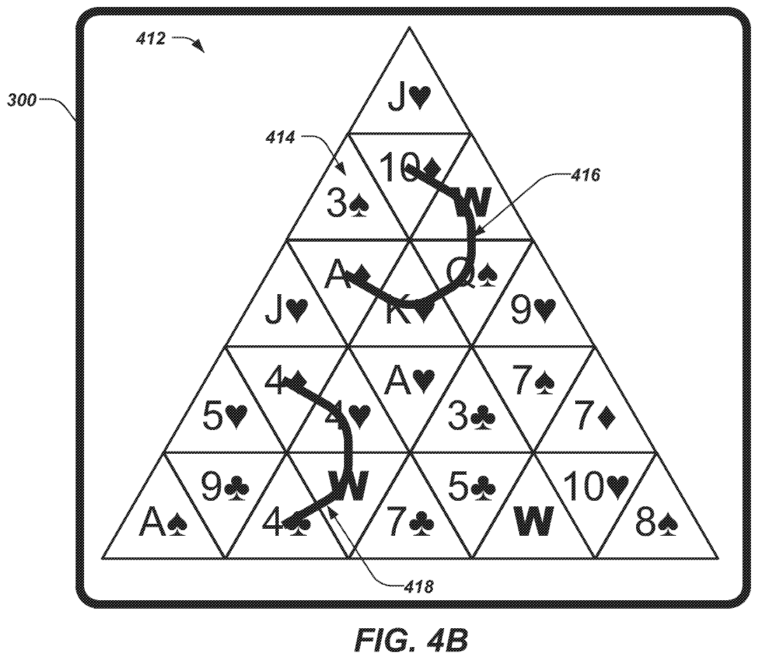

Although shown in FIGS. 3A and 3B as a rectangular matrix, the displayed matrix can take a variety of shapes, such as a triangle, a circle, etc. FIG. 4A illustrates an alternative matrix 402, with symbols 404 arranged in a generally circular pattern. Similar to traced paths of FIGS. 3A and 3B, the player can trace a path across the symbols 404 to select a winning hand, such as shown by path 406

Furthermore, the gameplay can be adjusted to suit the arrangement of symbols. As shown in FIG. 4A, the symbols are circular, providing a fluid layout such that distinct borderlines are not present between symbols. The path 410 may only cross symbols that are to be selected, however. Thus, symbols may be linked not only to immediately adjacent symbols, as shown by path 408 joining symbols via diagonal lines. Path 410 illustrates yet another method of selecting symbols for a hand. In this example, a continuous movement draws encircles the symbols to be selected. FIG. 4B is yet another alternative matrix 412 shaped as a triangle. Thus, symbols 414 can be selected and linked via one or more pathways 416, 418, consistent with the examples provided herein.

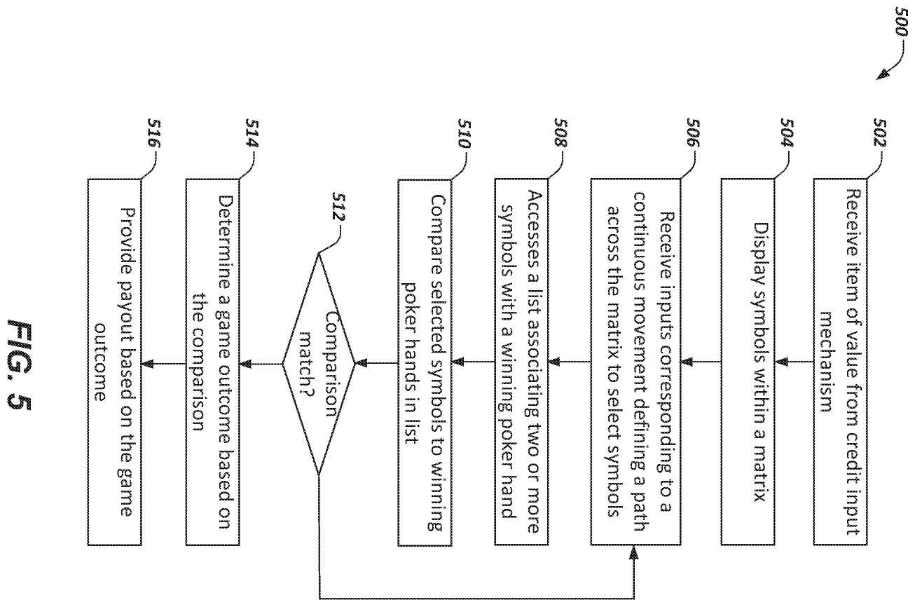

FIG. 5 illustrates a method 500 of playing an interactive electronic poker game, consistent with the examples provided herein. The method 500 can be executed as instructions or algorithms, stored on a memory device (e.g., memory 208), and executed via the game controller 200 (e.g., via one or more processors 204), as provided with respect to FIG. 2.

In block 502, an item of value is received, such as by a credit input mechanism (e.g., via bill validator 124 and/or player tracking card reader 144). In response, a credit balance is established that can be increased and/or decreased based on wagering activity from the player. In block 504, a plurality of symbols within a matrix (e.g., matrices 302, 402, 412) are displayed, such as on a touchscreen display (e.g., main display 128A, game displays 240, 242).

In block 506, a plurality of inputs are received to reflect selection of symbols (e.g., symbols 304, 404, 414) to form a poker hand. For example, a first input may correspond to contact with the touchscreen, thereby selecting a first symbol, where a second input may correspond to a continuous movement (i.e. dragging or tracing a path, such as paths 306, 308, 310, 406, 408, 410, 416, 418) from the first symbol to at least second selected symbol on the matrix. A third input may correspond to a liftoff event, such as breaking contact with the touchscreen, thereby completing the selection of symbols.

In block 508, the game controller accesses a list that associates two or more symbols to a winning poker hand. This list can be stored on a memory storage device, such as memory 208. In block 510, the selected symbols are compared to the list. At block 512, it is determined whether a match exists based on the comparison. If no winning poker hand is identified, the method returns to block 506 to receive additional user inputs for further evaluation. In some examples, an alert can be presented (e.g., visible, audible, or haptic) to the player indicating that no winning hand was identified.

If a winning poker hand has been identified by the comparison, a game outcome is determined based on the comparison in block 514. In block 516, a payout mechanism is controller to cause a payout based on the game outcome. For example, a royal flush may receive an increased payout or other bonus (e.g., additional time, a free play, etc.). A pair, however, may yield a smaller reward, as described herein.

The present disclosure solves challenges that are rooted in technologies associated with modern electronic wagering game machines, systems and methods. In particular, the electronic wagering game machines, systems and methods generate a wagering game, which is presented to a player. In response to the presented gameplay, a plurality of inputs are received from the player and interpreted. An outcome is determined based on the game and the inputs, and the player is rewarded accordingly. During gameplay, the technology that implements the wagering game machines, systems and methods are uniquely configured to focus on the gaming presentation (e.g., visual, audio, haptic, etc.) provided to the player over extraneous functionality, as well as accepting a limited number and variety of inputs from the player, in order to provide a more responsive experience.

For example, in the interactive poker game described with respect to FIGS. 3-5, the presentation themes are focused (in this example, to poker symbols), the networked information is focused (e.g., to presentation elements, security features associated with wagering games, etc.), as well as the player inputs. For instance, by accepting only a focused set of inputs, such as a first contact, a continuous movement to trace a path to select a limited number of symbols, followed by a lifting of contact upon completion of the path and selection, the machines, systems and methods described herein operate efficiently and with greater accuracy, while employing fewer computing resources than would be required on general purpose machinery.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

1. An interactive electronic game machine configured to receive and interpret a continuous movement input from a user for a matrix-based game comprising:
a credit input mechanism configured to receive an item of value to establish a credit balance, the credit balance being increasable and decreasable based at least on wagering activity; a display having a plurality of symbols displayed within a matrix;
a game controller operable in accordance with the credit balance to register an input for an interactive electronic poker game, the game controller configured to:
receive a first input corresponding to selection of a first symbol of the plurality of symbols;
receive a second input corresponding to a continuous movement from the first symbol to a second selected symbol of the plurality of symbols, the continuous movement defining a path across the matrix; and
determine a game outcome based on the selected symbols; and
a payout mechanism configured to cause a payout associated with the game outcome.

2. The interactive electronic gaming machine of claim 1, wherein the first and second symbols are in adjacent positions within the matrix.

3. The interactive electronic gaming machine of claim 1, wherein the path is a continuous line that connects the first symbol with the second symbol.

4. The interactive electronic gaming machine of claim 1, wherein the path defines a geometric shape that encircles both the first symbol and the second symbol.

5. The interactive electronic gaming machine of claim 1, wherein the path crosses a third selected symbol of the plurality of symbols, the game outcome being determined based on the selected first, second and third symbols.

6. The interactive electronic gaming machine of claim 1, wherein each of the plurality of symbols corresponds to one or more playing card values, the values comprising at least a ten, a jack, a queen, a king, an ace, or a wild.

7. The interactive electronic gaming machine of claim 6, wherein the path corresponds to selection of symbols corresponding to a royal flush.

8. The interactive electronic gaming machine of claim 1, wherein the controller is further configured to:
determine if the game outcome comprises a winning combination of selected symbols;
remove the selected symbols that comprise the winning combination; and
replace the selected symbols with substitute symbols.

9. The interactive electronic gaming machine of claim 1, wherein the controller is further configured to:
receive a third input corresponding to selection of a third symbol of the plurality of symbols;
receive a fourth input corresponding to a second continuous movement from the third symbol to a fourth selected symbol of the plurality of symbols, the second continuous movement defining a second path across the matrix; and
determine a second game outcome based on the selected third and fourth symbols.

10. The interactive electronic gaming machine of claim 1, wherein the input is provided on the touchscreen display via an input device comprising one of a stylus or a finger, wherein the input device remains in contact with the touchscreen display during the continuous movement.

11. The interactive electronic gaming machine of claim 1, wherein the gaming machine comprises a smartphone or tablet computer.

12. The interactive electronic gaming machine of claim 1, wherein the gaming machine comprises a stand-alone wagering system.

13. The interactive electronic gaming machine of claim 1, wherein the matrix is in the shape of a rectangle, triangle, or a circle.

14. An interactive electronic game machine configured to receive and interpret a continuous movement input from a user for a matrix-based game comprising:
a credit input mechanism configured to receive an item of value to establish a credit balance, the credit balance being increasable and decreasable based at least on wagering activity;
a display having a plurality of symbols displayed within a matrix; and
a game controller operable in accordance with the credit balance to register an input for an interactive skill based game, the game controller configured to:
receive a first input corresponding to a first continuous movement that defines a first path across the matrix, wherein each symbol of the plurality of symbols along the first path is selected for a first game outcome;
receive a second input corresponding to corresponding to a second continuous movement that defines a second path across the matrix, wherein each symbol of the plurality of symbols along the second path is selected for a second game outcome;
determine whether the first or second game outcomes comprises a winning combination of symbols; and
cause a payout mechanism to generate a payout in response to a winning combination.

15. The interactive electronic gaming machine of claim 14, further comprising a timer to define a duration of gameplay for the interactive skill based game, the game controller configured to:
receive a plurality of inputs corresponding to a plurality of game outcomes; and
determine a number of winning combinations based on the plurality of game outcomes.

16. The interactive electronic gaming machine of claim 14, wherein the payout mechanism is further configured to cause one or more payouts based on the determined number of winning combinations.

17. The interactive electronic gaming machine of claim 14, wherein the payout mechanism is further configured to cause an increased payout when each of the predetermined number game outcomes has been determined.

18. The interactive electronic gaming machine of claim 14, wherein interactive skill based game comprises an electronic poker game, such that each of the plurality of symbols corresponds to one or more playing card values, the values comprising a ten, a jack, a queen, a king, an ace, or a wild.

19. A method of executing an interactive electronic game machine configured to receive and interpret a continuous movement input from a user for a matrix-based poker game comprising:
receiving an item of value, by a credit input mechanism, to establish a credit balance, the credit balance being increasable and decreasable based at least on wagering activity;
displaying, by a touchscreen display, a plurality of symbols within a matrix;
receiving, by a game controller, a first input from an input device on the touchscreen display corresponding to selection of a first symbol of the plurality of symbols;
receiving, by the game controller, a second input from the input device corresponding to a continuous movement from the first symbol to a second selected symbol of the plurality of symbols such that the input device remains in contact with the touchscreen display during the continuous movement, the continuous movement defining a path across the matrix;
determining a game outcome based on the selected symbols; and
causing a payout, by a payout mechanism, based on the game outcome.

20. The method of claim 19, wherein determining the game outcome further comprises:
accessing, via a memory storage device, a list that associates two or more symbols to a winning poker hand;
comparing the selected symbols to the list; and
determining a game outcome based on the comparison.
